(19) United States
(12) Patent Application Publication
(10) Pub. No.: US 2003/0064844 A1
(43) Pub. Date: Apr. 3, 2003

(54) Sprocket combination having an assembling structure

(76) Inventor: Chang Hui Lin, Chang Hua Hsien (TW)

Correspondence Address: CHARLES E. BAXLEY, 5th Floor, 59 John Street, New York, NY, 10038, US

(21) Appl. No.: 09/967,396

(22) Filed: Oct. 1, 2001

(51) Int. Cl. F16H 9/00; F16H 59/00; F16H 61/00; F16H 55/12

(52) U.S. Cl. 474/160; 474/158; 474/78

(57) ABSTRACT

A sprocket combination includes two or more sprocket devices each having one or more sprockets extended from a hub. The side portions of the sprocket devices may be engaged or secured together with a peripheral bulge-and-peripheral recess engagement, and without additional calibrating process. One or more fasteners may further be engaged through the sprocket devices for further solidly securing the sprocket devices together. The smallest sprocket device may be made of stronger materials, and the other sprocket devices may be made of lighter and softer materials.

### BACKGROUND OF THE INVENTION

1. Field of the Invention

The present invention relates to a flywheel combination or a sprocket combination, and more particularly to a sprocket combination including one or more sprocket devices to be firmly secured together.

2. Description of the Prior Art

Typical flywheel combinations or sprocket combinations comprise a number of sprockets provided and disposed on a hub and radially extended outward from the hub. Some of the sprocket combinations comprise the sprockets solidly formed on the hub as an integral-one-piece structure. U.S. Pat. No. 4,353,447 to Bes discloses one of the typical sprocket combinations which are normally made of aluminum materials or alloys thereof or the like that may be easily manufactured or formed with a molding or fordging processes. The aluminum materials include a light weight which is a good characteristic for the sprocket combinations. However, the aluminum materials are softer than the other materials and may be easily worn out.

The other typical flywheel combinations or sprocket combinations comprise a number of sprockets each manufactured or formed with a molding or fordging processes separately or individually. After the sprockets are formed or manufactured, the sprockets are then disposed on and secured onto a hub, and may then be secured together with fasteners. U.S. Pat. No. 4,328,882 to Isobe discloses one of the typical sprocket combinations which are normally made of metal or steel materials or alloys thereof or the like. However, the metal or steel materials include a heavy weight that is adverse for the sprocket combinations. In addition, the sprockets are required to be secured and assembled onto the hub one by one, and all of the sprockets are required to be aligned and calibrated relative to each other to a high precision, for allowing the sprocket combination to be smoothly and swiftly operated. It may take a long time to assemble the large number of sprockets of the sprocket combination onto the hub before the sprocket combination may be assembled onto the cycle hubs.

The present invention has arisen to mitigate and/or obviate the afore-described disadvantages of the conventional sprocket combinations.

### SUMMARY OF THE INVENTION

The primary objective of the present invention is to provide a sprocket combination including one or more sprocket devices that may be firmly and solidly and quickly secured together.

In accordance with one aspect of the invention, there is provided a sprocket combination comprising a first sprocket device including a hub, and including at least one sprocket extended from the hub, and including a side portion having a peripheral bulge extended therefrom, and a second sprocket device including a hub, and including at least one first sprocket extended from the hub thereof, and including a side portion having a peripheral recess formed therein for receiving the peripheral bulge of the first sprocket device, and for securing the first and the second sprocket devices together without additional calibrating process.

The peripheral bulge of the first sprocket device includes a width greater than a width of the peripheral recess of the second sprocket device, for spacing the sprocket of the first sprocket device from the first sprocket of the second sprocket device.

The second sprocket device includes at least one second sprocket extended from the hub and spaced from the first sprocket thereof. The second sprocket device includes a spacer provided between the second sprocket and the first sprocket thereof for spacing the second sprocket and the first sprocket thereof from each other.

At least one fastener is further provided and engaged through the first and the second sprocket devices for securing the first and the second sprocket devices together. The first and the second sprocket devices each includes at least one groove formed in the hubs thereof respectively, for receiving the fastener.

A third sprocket device is further provided and includes a hub, and includes at least one first sprocket extended from the hub thereof, and includes a side portion having a peripheral recess formed therein, the second sprocket device includes a peripheral bulge extended therefrom opposite to the peripheral recess of the second sprocket device for engaging into the peripheral recess of the third sprocket device, and for securing the second and the third sprocket devices together without additional calibrating process.

The second sprocket device includes a spacer extended therefrom for engaging with the first sprocket of the third sprocket device, and for spacing the first sprocket of the third sprocket device from the first sprocket of the second sprocket device.

The third sprocket device includes at least one second sprocket extended from the hub thereof and spaced from the first sprocket thereof, and includes a spacer provided between the second sprocket and the first sprocket thereof for spacing the second sprocket and the first sprocket thereof from each other.

The fastener may also be engaged through the second and the third sprocket devices for securing the second and the third sprocket devices together. The third sprocket device also includes at least one groove formed in the hub thereof for receiving the fastener.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a plan schematic view of a sprocket combination in accordance with the present invention;

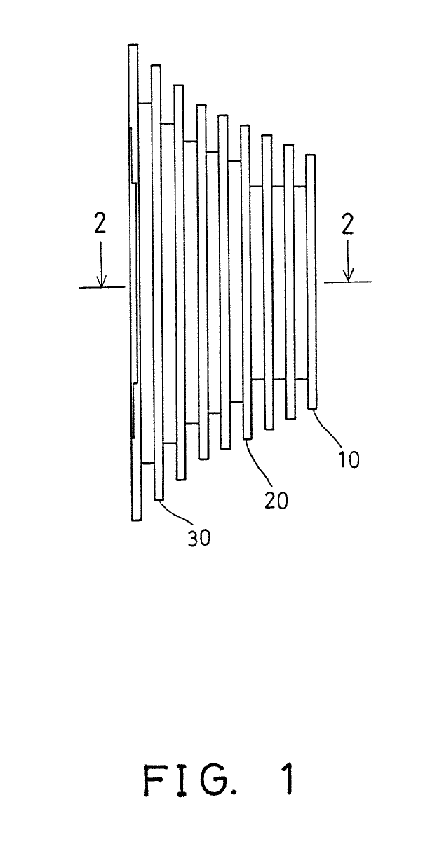

FIG. 2 is a cross sectional view taken along lines 2-2 of FIG. 1; and

FIG. 3 is an exploded and cross sectional view illustrating the sprocket devices of the sprocket combination.

### DETAILED DESCRIPTION OF THE PREFERRED EMBODIMENT

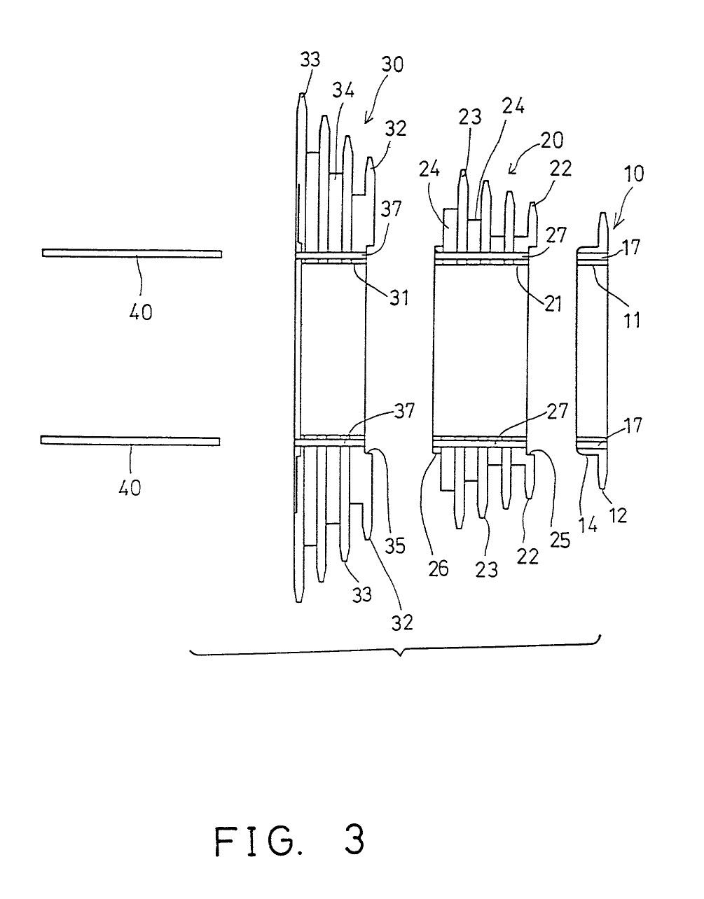

Referring to the drawings, a sprocket combination in accordance with the present invention comprises two or more sprocket devices 10, 20, 30 that may be solidly secured together. The sprocket devices 10, 20, 30 each includes a hub 11, 21, 31, and each includes one or more sprockets 11, 22, 23, 32, 33 extended from and formed integral as one-integral-piece with the respective hub 11, 21, 31, best shown in FIG. 3. For example, the right or the smallest or the first sprocket device 10 includes a single sprocket 12 extended radially outward from the hub 11 thereof. The other, or the greater, or the intermediate and the left, or the second and the third sprocket devices 20, 30 each includes two or more sprockets 22, 23, 32, 33 extended radially outward from the hubs 21, 31 thereof respectively, such that the sprockets 22, 23, 32, 33 are not required to be further assembled onto the hubs 21, 31 respectively.

The second and the third sprocket devices 20, 30 each further includes one or more spacers 24, 34 formed or provided between the sprockets 22, 23, 32, 33 respectively, for determining the spacing distances between the sprockets 22, 23, 32, 33. The rightmost or the smallest sprocket 22 of the intermediate or the second sprocket device 20 includes an outer diameter no less than that of the sprocket 12 of the first sprocket device 10, and smaller than that of the other sprockets 23 of the second sprocket device 20. The rightmost or is the smallest sprocket 32 of the third sprocket device 30 also preferably includes an outer diameter no less than that of the largest sprocket 23 of the second sprocket device 20, and smaller than that of the other sprockets 33 of the third sprocket device 30.

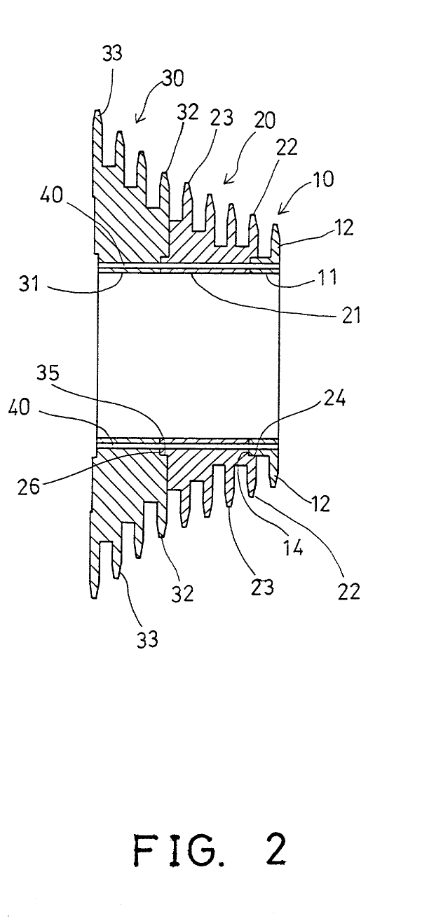

The second sprocket device 20 includes an inner peripheral recess 25 formed in the right portion thereof, for example, and includes an outer peripheral bulge 26 formed or extended outward or leftward from the left portion thereof, for example. The first sprocket device 10 includes an outer peripheral bulge 14 formed or extended outward or leftward from the left portion thereof, for example, for engaging into the inner peripheral recess 25 of the second sprocket device 20, such that the first and the second sprocket devices 10, 20 may be aligned with each other without further calibrating processes, and such that the first and the second sprocket devices 10, 20 may be prevented from moving radially relative to each other. The outer peripheral bulge 14 of the sprocket device 10 includes a width or a thickness greater than the inner peripheral recess 25 of the second sprocket device 20, best shown in FIG. 2, for spacing the smallest sprocket 22 of the second sprocket device 20 and the sprocket 12 of the first sprocket device 10 from each other.

The third sprocket device 30 includes an inner peripheral recess 35 formed in the right portion thereof, for example, for receiving the outer peripheral bulge 26 of the second sprocket-device 20, such that the second and the third sprocket devices 20, 30 may be aligned with each other without further calibrating processes, and such that the second and the third sprocket devices 20, 30 may be prevented from moving radially relative to each other. The second sprocket devices 20 includes a spacer 24 formed or provided on the left portion thereof for engaging with the smallest sprocket 32 of the third sprocket device 30 and for spacing the smallest sprocket 32 of the third sprocket device 30 and the largest sprocket 23 of the second sprocket device 20 from each other. The first and the second and the third sprocket devices 10, 20, 30 may be solidly secured together with such as a force-fitted engagement, such that the concentricity of the sprockets 11, 22, 23, 32, 33 of the sprocket devices 10, 20, 30 may be facilitated or maintained or obtained.

The first and the second and the third sprocket devices 10, 20, 30 each further includes one or more grooves 17, 27, 37 formed therein, such as formed through the hubs 11, 21, 31 thereof, for receiving a pin or a rod or a fastener 40 therein respectively, and for allowing the first and the second and the third sprocket devices 10, 20, 30 to be further solidly secured together. The grooves 17, 27, 37 of the sprocket devices 10, 20, 30 may include a suitable inclination or inclined inner peripheral surface (not shown) for engaging with a corresponding inclination or an inclined outer peripheral surface (not shown) of the fastener 40, and for allowing the fasteners 40 to be solidly secured in the grooves 17, 27, 37 of the sprocket devices 10, 20, 30. The sprockets 11, 22, 23, 32, 33 of the sprocket devices 10, 20, 30 thus will not become loose and will not be moved relative to each other, and for allowing the sprocket combination to be effectively and smoothly and swiftly and precisely operated.

It is to be noted that the first sprocket device 10 includes the smallest outer diameter and will be subjected with the greatest force, and will be used the most frequently, such that the first sprocket device 10 is preferably made of the strongest materials, such as the steel materials, for increasing the working life of the first sprocket device 10. The second and the third sprocket devices 20, 30 are normally used with a less frequency, and may thus be made of lighter and softer materials, such as the aluminum and the alloys thereof, for example, for decreasing the weight of the sprocket combination. The sprocket combination may include two, three, four or more sprocket devices secured or assembled together, according to the users need or requirement.

Accordingly, the sprocket combination in accordance with the present invention includes one or more sprocket devices that may be firmly and solidly and quickly secured together.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A sprocket combination comprising:
a first sprocket device including a hub, and including at least one sprocket extended from said hub, and including a side portion having a peripheral bulge extended therefrom, and
a second sprocket device including a hub, and including at least one first sprocket extended from said hub thereof, and including a side portion having a peripheral recess formed therein for receiving said peripheral bulge of said first sprocket device, and for securing said first and said second sprocket devices together without additional calibrating process.

2. The sprocket combination according to claim 1, wherein said peripheral bulge of said first sprocket device includes a width greater than a width of said peripheral recess of said second sprocket device, for spacing said at least one sprocket of said first sprocket device from said at least one first sprocket of said second sprocket device.

3. The sprocket combination according to claim 1, wherein said second sprocket device includes at least one second sprocket extended from said hub and spaced from said at least one first sprocket thereof.

4. The sprocket combination according to claim 3, wherein said second sprocket device includes a spacer provided between said at least one second sprocket and said at least one first sprocket thereof for spacing said at least one second sprocket and said at least one first sprocket thereof from each other.

5. The sprocket combination according to claim 1 further comprising at least one fastener engaged through said first and said second sprocket devices for securing said first and said second sprocket devices together.

6. The sprocket combination according to claim 5, wherein said first and said second sprocket devices each includes at least one groove formed in said hubs thereof respectively, for receiving said at least one fastener.

7. The sprocket combination according to claim 1 further comprising a third sprocket device including a hub, and including at least one first sprocket extended from said hub thereof and including a side portion having a peripheral recess formed therein, said second sprocket device including a peripheral bulge extended therefrom opposite to said peripheral recess of said second sprocket device for engaging into said peripheral recess of said third sprocket device, and for securing said second and said third sprocket devices together without additional calibrating process.

8. The sprocket combination according to claim 7, wherein said second sprocket device includes a spacer extended therefrom for engaging with said at least one first sprocket of said third sprocket device, and for spacing said at least one first sprocket of said third sprocket device from said at least one first sprocket of said second sprocket device.

9. The sprocket combination according to claim 7, wherein said third sprocket device includes at least one second sprocket extended from said hub thereof and spaced from said at least one first sprocket thereof, and includes a spacer provided between said at least one second sprocket and said at least one first sprocket thereof for spacing said at least one second sprocket and said at least one first sprocket thereof from each other.

10. The sprocket combination according to claim 7 further comprising at least one fastener engaged through said second and said third sprocket devices for securing said second and said third sprocket devices together.

11. The sprocket combination according to claim 10, wherein said second and said third sprocket devices each includes at least one groove formed in said hubs thereof respectively, for receiving said at least one fastener.

12. A sprocket combination comprising:
a first sprocket device including a hub, and including at least one sprocket extended from said hub,
a second sprocket device including a hub, and including a first sprocket and at least one second sprocket extended from said hub thereof, and
at least one fastener engaged through said first and said second sprocket devices for securing said first and said second sprocket devices together.

13. The sprocket combination according to claim 12, wherein said first and said second sprocket devices each includes at least one groove formed in said hubs thereof respectively, for receiving said at least one fastener.

14. The sprocket combination according to claim 12, wherein said first sprocket device includes a side portion having a peripheral bulge extended therefrom, and said second sprocket device includes a side portion having a peripheral recess formed therein for receiving said peripheral bulge of said first sprocket device.

15. The sprocket combination according to claim 14, wherein said peripheral bulge of said first sprocket device includes a width greater than a width of said peripheral recess of said second sprocket device, for spacing said at least one sprocket of said first sprocket device from said first sprocket of said second sprocket device.

16. The sprocket combination according to claim 12, wherein said second sprocket device includes a spacer provided between said at least one second sprocket and said first sprocket thereof for spacing said at least one second sprocket and said first sprocket thereof from each other.

17. The sprocket combination according to claim 12 further comprising at least one third sprocket device including a hub, and including a first sprocket and at least one second sprocket extended from said hub thereof, and said at least one fastener being engaged through said first and said second and said at least one third sprocket devices.

18. The sprocket combination according to claim 17, wherein said second sprocket device includes a side portion having a peripheral bulge extended therefrom, said at least one third sprocket device includes a side portion having a peripheral recess formed therein for receiving said peripheral bulge of said second sprocket device and for securing said second and said at least one third sprocket devices together.

19. The sprocket combination according to claim 12, wherein said at least one second sprocket of said second sprocket device includes an outer diameter greater than that of said first sprocket of said second sprocket device, said first sprocket of said second sprocket device includes an outer diameter no less than that of said at least one sprocket of said first sprocket device.
